(19) United States
(12) Patent Application Publication
(10) Pub. No.: US 2026/0164256 A1
(43) Pub. Date: Jun. 11, 2026

(54) GENERATING ARTIFACTS USING MULTI-MODAL DOCUMENT INDEXING AND RETRIEVAL-AUGMENTED GENERATION

(71) Applicant: T-Mobile USA, Inc., Bellevue, WA (US)

(72) Inventors: Srikrishna Srinivasan, Sammamish, WA (US); Yanbing Su, Frisco, TX (US); Faisal Waris, Rochester Hills, MI (US)

(21) Appl. No.: 18/977,474

(22) Filed: Dec. 11, 2024

(51) Int. Cl. H04W 16/22; G06F 16/3329; G06F 16/334; H04L 51/02

(52) U.S. Cl. CPC H04W 16/22; G06F 16/3329; G06F 16/3347; H04L 51/02

(57) ABSTRACT

A computer system obtains documents containing telecommunications network equipment configurations. Using a chat bot interface, the system captures an output type instruction specifying desired artifact features (e.g., format, timestamp, keywords, location, user role) for constructing or maintaining the equipment. The system uses a first AI model to identify reference documents from the obtained documents by comparing vector representations of the documents with the instruction. The reference documents share one or more features with the artifact. A second model uses the reference documents to generate a response to the output type instruction. The chat bot interface displays both the generated artifact and the reference documents.

### BACKGROUND

Wireless telecommunications networks enable mobile devices to communicate over long distances using radio frequency signals. The networks typically include base stations that provide coverage for geographic areas, forming cells where mobile devices can connect and exchange data. As networks evolve, there is an increasing need for efficient deployment and maintenance of network infrastructure. Network deployment and maintenance include processes associated with site selection, equipment installation, configuration, and ongoing modifications. General contractors and field technicians use extensive technical documentation and best practices to build out and maintain wireless networks. However, the complexity of the required documentation creates significant challenges for field technicians who often need to access and interpret the technical information quickly and accurately to ensure proper installation and maintenance of network equipment.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram illustrating an example environment for processing and retrieving information to generate artifacts.

FIG. 3A is a screenshot of an example user interface displaying an input field of an artifact generation platform.

FIG. 3B is a screenshot of the example user interface displaying a generated response to a user query.

FIG. 3C is a screenshot of the example user interface displaying a reference document within the generated response to the user query.

FIG. 3D is a screenshot of the example user interface displaying a user feedback component.

FIG. 4 is a block diagram illustrating an example dashboard for monitoring the artifact generation platform's performance.

FIG. 5 is a flowchart illustrating an example method for generating artifacts on the artifact generation platform.

FIG. 6 is a high-level block diagram illustrating an example AI system.

FIG. 7 is a block diagram that illustrates an example of a computer system in which at least some operations described herein can be implemented.

The technologies described herein will become more apparent to those skilled in the art from studying the Detailed Description in conjunction with the drawings. Implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Wireless telecommunications networks enable mobile devices to communicate over long distances using radio frequency signals. The telecommunications networks may include base stations that provide coverage for geographic areas, forming cells where mobile devices can connect and exchange data. As networks increase in complexity, there is an increasing need for efficient deployment and maintenance of network infrastructure. Network deployment and maintenance include processes associated with site selection, equipment installation, configuration, and ongoing modifications. General contractors and field technicians may rely on extensive technical documentation to build out and maintain wireless networks. However, accessing relevant information during construction and maintenance processes can be challenging. The volume and complexity of technical documents, specifications, and procedures make it difficult to find specific details needed for a particular task or troubleshooting scenario, which can lead to delays, errors, and/or inefficiencies in network deployment and maintenance activities. Furthermore, the rapid pace of technological advancements in telecommunications networks results in continuously evolving documentation and/or sets of best practices. Using outdated or incorrect information can result in unsatisfactory network performance, increased downtime, and/or higher operational costs. Additionally, the interpretations of technical information may not be consistent across different sites or regions, which may lead to inconsistencies in network implementation and maintenance across different sites or regions.

Artificial intelligence and machine learning (AI/ML) systems have become increasingly important in generating project artifacts for various industries including telecommunications. However, conventional systems face several technical challenges when processing large amounts of multi-modal information and generating complex artifacts. Conventional systems struggle to effectively integrate and process diverse data types such as images, videos, technical documents, and audio recordings of the input documentation. Multi-modal inputs may cause conventional systems to disproportionately focus on certain data types due to inherent differences in data representation and processing requirements for each modality, leading to incomplete or skewed artifacts. Systems often fail to maintain balanced information representation across modalities, resulting in modality bias, information loss at modality boundaries, temporal misalignment, resolution and detail imbalance, contextual misinterpretation, and so forth. For instance, an AI model may prioritize textual information from instruction manuals while underutilizing visual data in equipment schematics to produce artifacts that accurately describe specifications but omit important assembly instructions from the visual data. In telecommunications network equipment contexts, such incomplete artifacts can lead to misconfigurations, inefficient maintenance, or safety hazards.

Disclosed herein are systems, methods, and computer-readable media for automatically generating artifacts using multi-modal information (hereinafter the “artifact generation platform”). In some implementations, the artifact generation platform can be implemented in relation to chat bots for constructing or maintaining network equipment. For example, the artifact generation platform can be used to generate artifacts in response to queries associated with cellular base stations (or other network equipment). The artifact generation platform can obtain a set of images (or other documents/content, such as text, audio, video, and so forth) including configurations of the network equipment, capture an output type instruction using a graphical user interface (e.g., of a chat bot), and generate an artifact (e.g., answer to a question, reference documents, particular timestamp in a video, particular page in a document, and so forth) using the output type instruction. To generate the artifact, a first artificial intelligence (AI) model can generate a set of reference images and a second AI model (which can be the same as or different from the first AI model) to generate a body of text describing the reference images. The artifact generation platform can display the generated artifact and the set of reference images at the graphical user interface of the chat bot.

In some implementations, the artifact generation platform can intake various types of input data, including Portable Document Format (PDF) files, audio files, and/or videos. The generated artifacts can include hyperlinks to each image in the set of reference images. The artifact generation platform can calculate relevance scores for the reference images based on factors such as keyword frequency, proximity, creation date, modification date, and/or source confidence. The reference images may be sorted and displayed based on the relevance scores. Additionally, the artifact generation platform can associate metadata with the output type instruction and generated artifact, including timestamps, user roles, reference images, and/or confidence scores. The artifact generation platform can enable users to download generated artifacts in selected formats, automatically converting the artifacts as needed.

The artifact generation platform can generate customized artifacts based on specific queries to help technicians and contractors quickly access the information they need and reduce the time spent searching through extensive documentation. The incorporation of visual elements, such as reference images or videos, reduces the likelihood of misinterpretation and maintains consistency in implementation across different sites and regions, improving overall quality and reliability of telecommunications networks. Further, by converting different input data types into unified vector representations, the artifact generation platform generates contextually relevant embeddings for each data type. The embeddings capture semantic relationships within and across modalities, allowing for nuanced similarity comparisons and significantly reducing the risk of modality bias and information loss.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

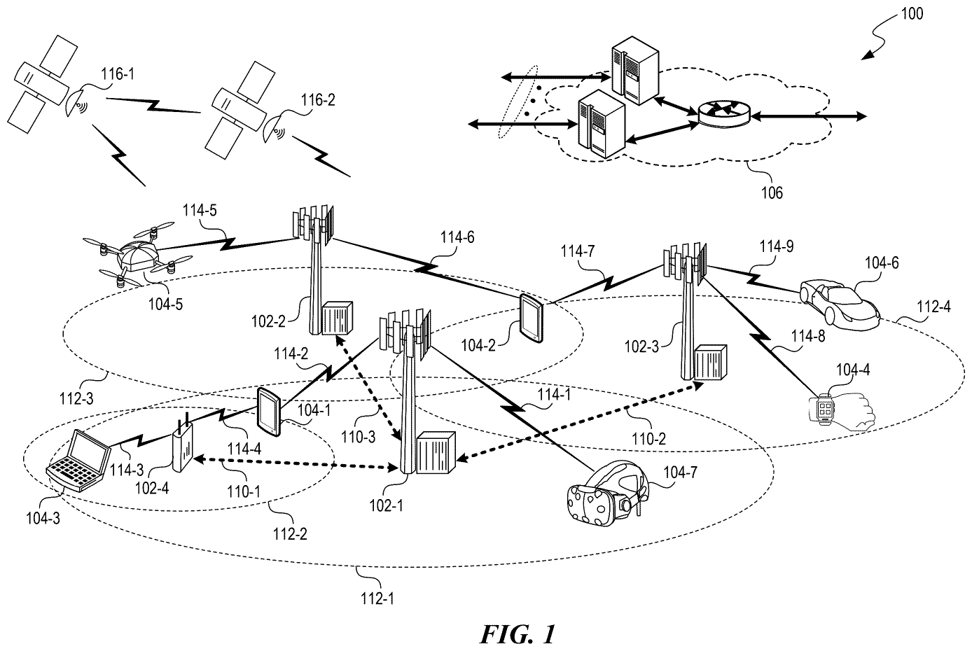

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNB, or the like. In addition to being a wireless wide area network (WWAN) base station, a NAN can be a wireless local area network (WLAN) access point, such as an Institute of Electrical and Electronics Engineers (IEEE) 402.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 gigahertz (GHz) or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces for LTE) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., Xn interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communications networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The DL transmissions can also be called forward link transmissions while the UL transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) (e.g., using unpaired spectrum resources) operation. In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a non-terrestrial network (NTN) is enabled by one or more satellites, such as satellites 116-1 and 116-2, to deliver services anywhere and anytime and provide coverage in areas that are unreachable by any conventional terrestrial network (TN). A 6G implementation of the network 100 can support terahertz (THz) communications. This can support wireless applications that demand ultra-high quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and core architecture to achieve Control and User Plane Separation (CUPS) and achieve extremely low user plane latency. In yet another example of 6G, the network 100 can implement a converged Wi-Fi and core architecture to increase and improve indoor coverage.

### Example Implementations of an Artifact Generation Platform

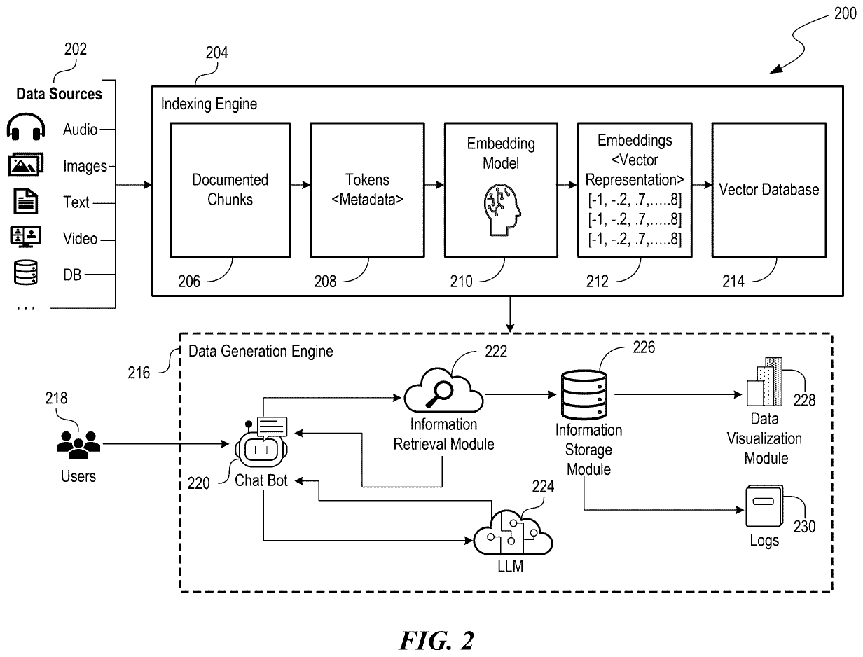

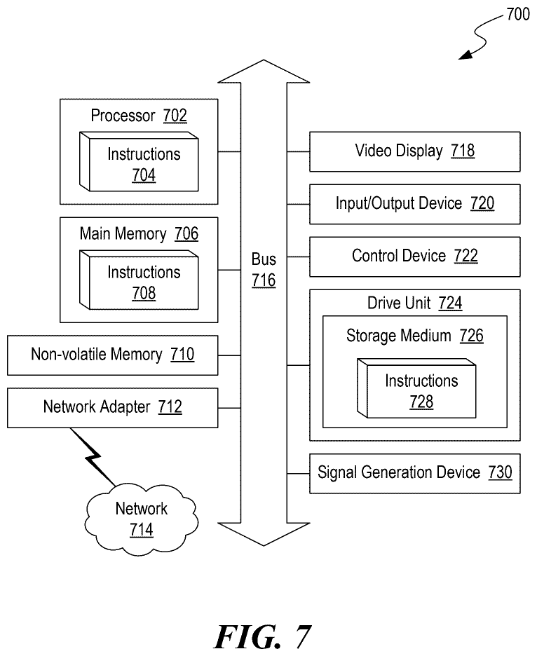

FIG. 2 is a block diagram illustrating an example environment 200 for processing and retrieving information to generate artifacts. The environment 200 includes data sources 202, indexing engine 204, documented chunks 206, tokens 208, embedding model 210, embeddings 212, vector database 214, data generation engine 216, users 218, chat bot 220, information retrieval module 222, AI model 224, information storage module 226, data visualization module 228, and logs 230. The environment 200 can be implemented using components of the example computer system 700 illustrated and described in more detail with reference to FIG. 7. Implementations of example environment 200 can include different and/or additional components or can be connected in different ways.

The data sources 202 can include various types of input data such as audio, images, text, video, and/or database information containing visual and textual information. The data sources 202 can be related to the configuration and setup of telecommunications network equipment. In some implementations, the data sources 202 can include PDF files or videos. The PDF files can include content related to technical manuals, regulatory documents, and/or engineering drawings, while videos can provide visual instructions and demonstrations of equipment setup and maintenance procedures. In some implementations, the data sources 202 can include real-time data streams from IoT devices installed at the cell sites to provide live updates on equipment status and/or environmental conditions (e.g., monitoring parameters such as temperature, humidity, power levels, and signal strength).

In some implementations, the data sources 202 can include structured data from relational databases storing records of, for example, equipment specifications, maintenance schedules, and/or historical performance data. The structured data can be queried and retrieved using Structured Query Language (SQL) commands. In some implementations, the data sources 202 can include unstructured data obtained from web scraping, for example vendor websites, regulatory portals, and/or industry forums. In some implementations, the data obtained can include the entire lifecycle of the data (e.g., from creation and storage to archiving), and provide information related to version control, audit trails, and potential amendments to the data across time.

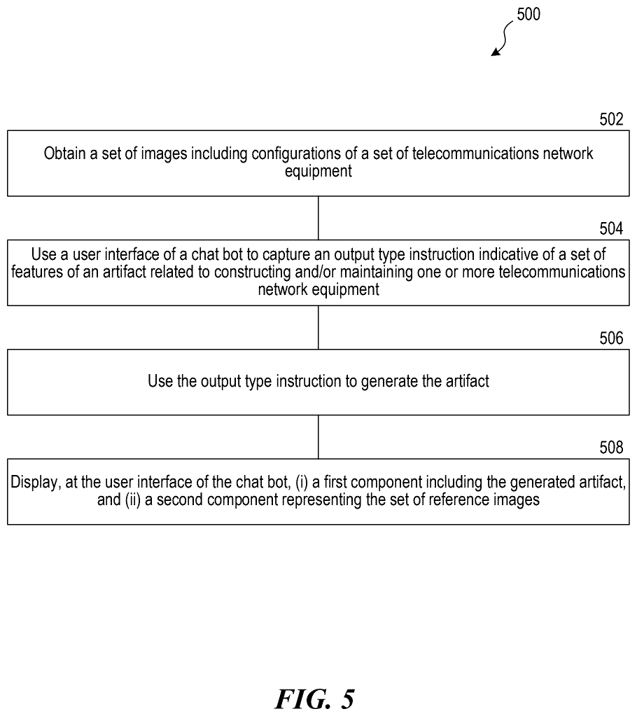

The indexing engine 204 segments the structured and/or unstructured data from the data sources 202 into the documented chunks 206, or logical units such as words, sentences, or paragraphs segmented based on defined rules to maintain semantic integrity. For instance, the indexing engine 204 can use named entity recognition (NER) to identify and categorize key terms and entities within the documents, such as equipment names, model numbers, and technical specifications. Further methods of chunking the documents are discussed with reference to FIG. 5. In some implementations, the documented chunks 206 can include metadata tags to provide additional context. The metadata tags can include information such as the document source, creation date, author, and/or relevance scores. Metadata provides additional layers of information that can be used to filter and rank the results. For example, a chunk containing a technical specification can be tagged with the equipment type, version number, and applicable standards, making the information within the chunk easier to locate and reference in response to specific queries.

The tokens 208 are the individual elements produced by tokenizing the documented chunks 206, or breaking down the chunks into smaller units, such as words, sub-words, or characters, depending on the granularity used in the embedding model 210. The embedding model 210 can convert the tokens 208 into numerical vector representations such as embeddings 212 using methods discussed in further detail in FIG. 5. The embeddings 212 can capture the semantic meaning of the tokens within the context of the surrounding text. In some aspects, the embedding model 210 can use techniques such as Word2Vec, GloVe, or BERT to generate the embeddings. The vector database 214 stores the embeddings 212 along with associated metadata. The vector database 214 can retrieve information from data sources 202 based on the semantic content of the data using methods discussed in further detail in FIG. 5.

The data generation engine 216 interfaces with users 218 through a chat bot 220 to process queries and generate artifacts. The chat bot 220 can provide a conversational interface for users to input queries and receive responses. In some aspects, the chat bot 220 can support multi-modal inputs including text, voice, and images. When a user query is received via the chat bot 220, the data generation engine 216 searches the vector database 214 using the information retrieval module 222. The information retrieval module 222 can use similarity search techniques discussed in further detail with reference to FIG. 5 to identify the most semantically relevant data.

The AI model 224 uses the retrieved information to generate responses to user queries. The AI model 224 can be a large language model (LLM) or other type of generative AI system (e.g., a system capable of natural language understanding and generation). The AI model 224 can use techniques such as few-shot learning or in-context learning to adapt to specific query types. The information storage module 226 can store the information retrieved by the information retrieval module 222 and/or additional structured data used to supplement the information retrieved from the vector database 214. For example, the information storage module 226 can include additional context such as user information, up-to-date equipment specifications, maintenance schedules, or other domain-specific information.

The data visualization module 228 can present information retrieved from the information storage module 226 or generated by the AI model 224 in visual formats such as charts, graphs, or interactive diagrams. The logs 230 can capture user queries, system responses, processing times, and/or other relevant metrics. In some implementations, the logs 230 can be used to retrain or fine-tune the AI models used in the artifact generation platform and/or used for monitoring purposes using methods discussed in further detail with reference to FIG. 5.

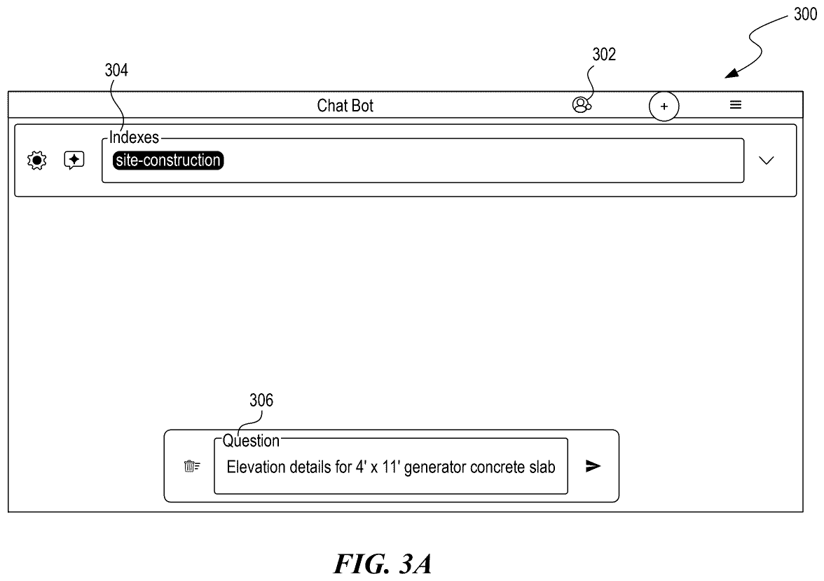

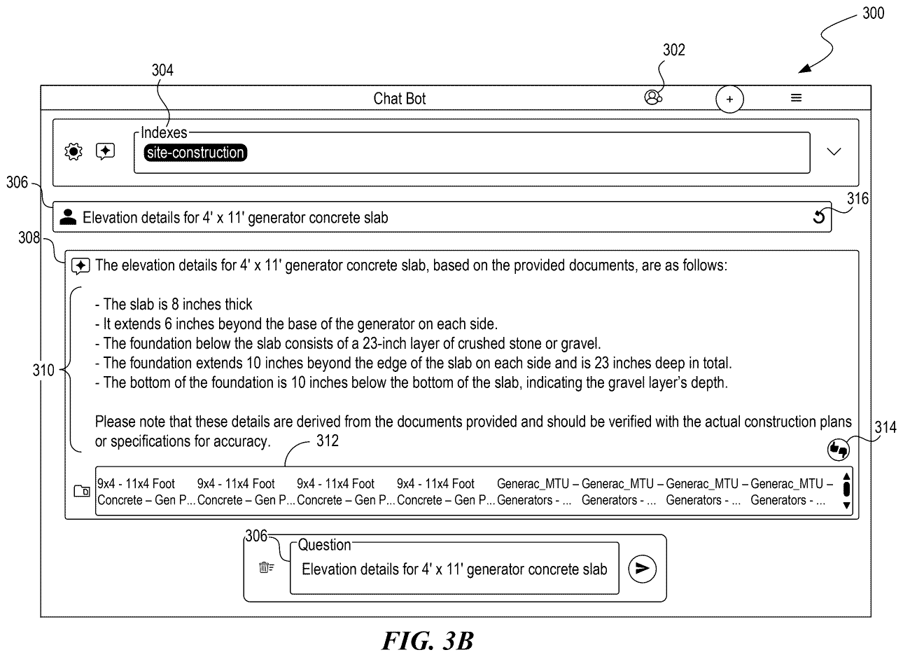

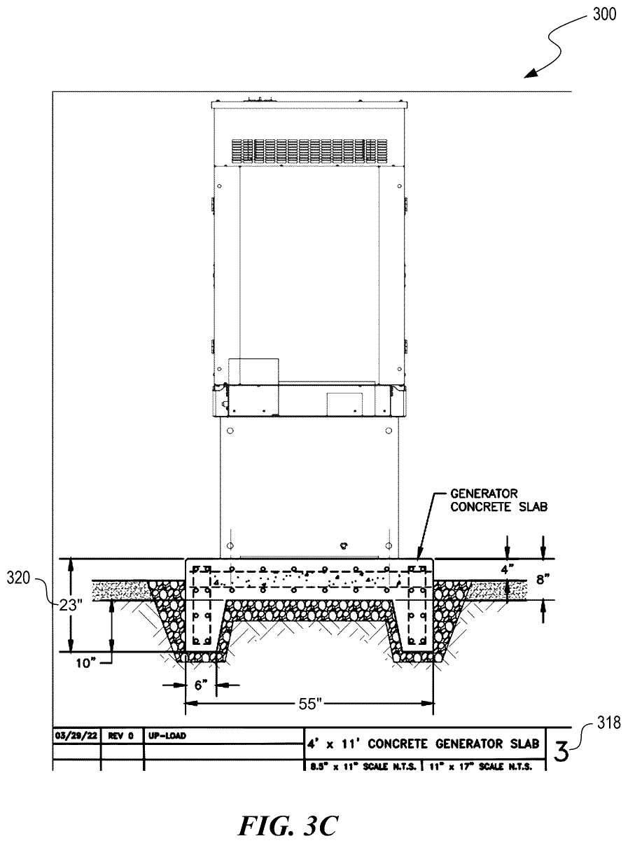

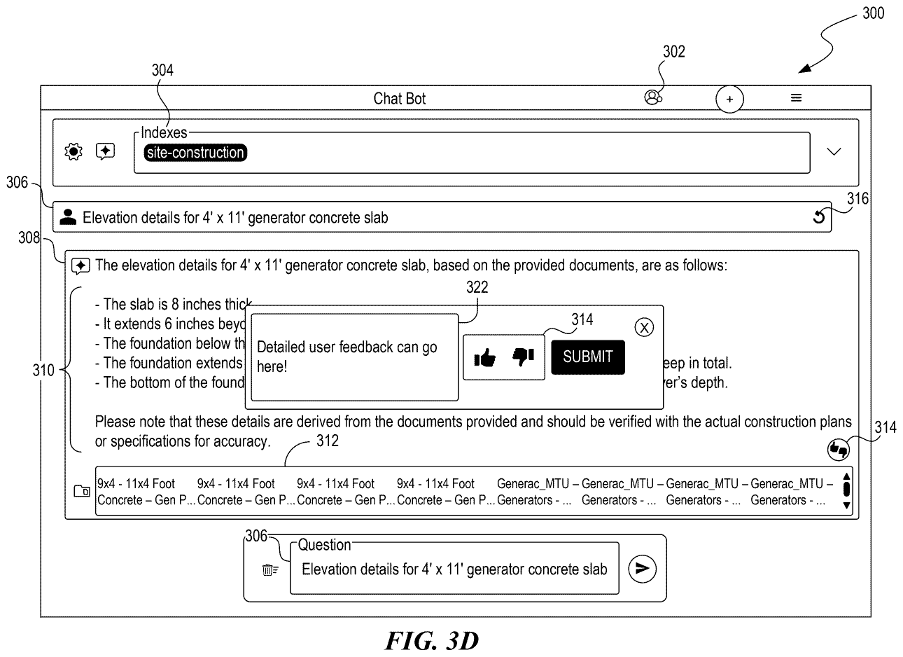

FIGS. 3A-3D are screenshots of an example user interface 300 of the artifact generation platform. The user interface 300 can be a graphical representation of the artifact generation platform that interacts with the user. The user interface 300 can be implemented using components of the example computer system 700 illustrated and described in more detail with reference to FIG. 7. Implementations of example user interface 300 can include different and/or additional components or can be connected in different ways.

In particular, FIG. 3A is a screenshot of the user interface 300 that includes user identifier 302, indexes 304, and an input field displaying an input 306. The user interface 300 can be a chat bot interface. The user identifier 302 refers to a unique designation assigned to each user or user group of the artifact generation platform. The user identifier 302 distinguishes individual users or user groups within the artifact generation platform and can be used to store personalized context, implement access control to particular documents, and/or track user interactions. The user identifier 302 can be implemented as a username, email address, and/or a system-generated unique code, such as a Universally Unique Identifier (UUID) or a hash-based identifier. In some implementations, the user identifier 302 can be associated with specific roles or permissions, allowing the artifact generation platform to tailor its responses and available features based on the user's authorization level.

Indexes 304 can refer to a specific dataset or knowledge base that the artifact generation platform uses to process the user's query and generate the artifact. In some implementations, multiple indexes can be used to switch or add different domains or types of information. The indexes 304 are organized/structured collections of data that the artifact generation platform can search and retrieve information from when processing user queries. Each index can correspond to a particular domain of knowledge, such as site construction, equipment specifications, or maintenance procedures. For example, in FIG. 3A, the index “site-construction” is set to provide context to the artifact generation platform that the queries and generating artifacts are related to the construction of telecommunications sites. For example, the documents retrieved using the index “site-construction” can include technical specifications, equipment details, construction procedures, and/or regulatory requirements for building telecommunications infrastructure.

The input field enables users to enter inputs 306 (e.g., queries or prompts) related to, for example, telecommunications network equipment construction or maintenance. The input field can accept natural language queries, allowing users to phrase the users' questions or requests in a conversational manner. For example, in FIG. 3A, the input field displays the input 306: “Elevation details for 4′×11′ generator concrete slab.” In some implementations, the input 306 can support multi-modal input 306, allowing users to attach images, documents, or other media types to provide additional context for the users' queries.

FIG. 3B is a screenshot of the user interface 300 displaying a generated response to a user query. The user interface 300 in FIG. 3B includes an artifact 308, a description 310, reference documents 312, a feedback indicator 314, and a regeneration indicator 316. The artifact 308 refers to the generated response produced by the artifact generation platform based on the user's input 306. The artifact 308 is a structured output that includes relevant information (e.g., description 310 and reference documents 312) extracted and synthesized from an indexed knowledge base to address the user's query. In some implementations, the artifact 308 can be presented in various formats, such as plain text, formatted text with headings and bullet points, or another structured data object, depending on the nature of the query and the artifact generation platform's capabilities.

The description 310 can be a textual component of the artifact 308 that provides an explanation or answer to the user's query. The description 310 can be generated using the indexed documents and using methods discussed in reference to FIG. 5. In some implementations, the description 310 can include technical specifications, procedural steps, and/or explanatory text specific to the user's query and authorization level. Reference documents 312 are indicators such as visual representations or links to the source materials used by the artifact generation platform to create the artifact 308. The reference documents 312 can be displayed as thumbnails, document titles, or interactive hyperlinks that allow users to access the original sources for more detailed information. In some implementations, the reference documents 312 can be ranked or sorted based on the reference documents' 312 relevance to the user's query, with the most relevant sources displayed prominently. Relevance-based ranking methods are further discussed with reference to FIG. 5.

The feedback indicator 314 is a user interface element that allows users to provide feedback on the quality, relevance, or accuracy of the generated artifact 308. This feedback mechanism can be a thumbs up/down button, a star rating system, and/or other feedback form. In some implementations, the feedback indicator 314 can be used to collect data for retraining the artifact generation platform using methods discussed with reference to FIG. 5. The regeneration indicator 316 is a user interface element that allows users to request a new or refined artifact based on the same input 306 or with additional context. The regeneration indicator 316 can be used, for example, when the initial artifact 308 does not fully address the user's needs or when the user wants to explore alternative perspectives on the same query. In some implementations, the regeneration indicator 316 can trigger a dialog box for users to provide additional parameters or constraints for the regeneration process.

FIG. 3C is a screenshot of the user interface 300 displaying a reference document within the generated response to the user query. The user interface 300 in FIG. 3C includes a page indicator 318 and specifications 320. The page indicator 318 is a user interface element that provides information about the current page or section of the reference document being displayed. The page indicator 318 can show the page number, section title, or other relevant metadata to help users navigate through multi-page or multi-section documents. In some implementations, the page indicator 318 can be interactive, allowing users to jump to specific pages or sections of the reference document. The specifications 320 refer to the technical information displayed within the reference document. In the context of the example query about a generator concrete slab, the specifications 320 include precise measurements (e.g., 23-inch height in FIG. 3C), dimensions, and structural details of the concrete slab. The specifications 320 can be presented in various formats, such as technical drawings, diagrams, or textual descriptions, depending on the nature of the information and the source document.

FIG. 3D is a screenshot of the user interface 300 displaying a user feedback component. The user interface 300 in FIG. 3D includes user feedback 322. The user feedback 322 is a component that allows users to provide detailed input on the quality, relevance, or accuracy of the generated artifact. The user feedback 322 can be implemented as a text input field where users can enter the users' comments, suggestions, or critiques regarding the artifact or the overall system performance. In some implementations, the user feedback 322 can include structured elements such as rating scales, multiple-choice questions, or predefined categories to help users provide more specific and actionable feedback.

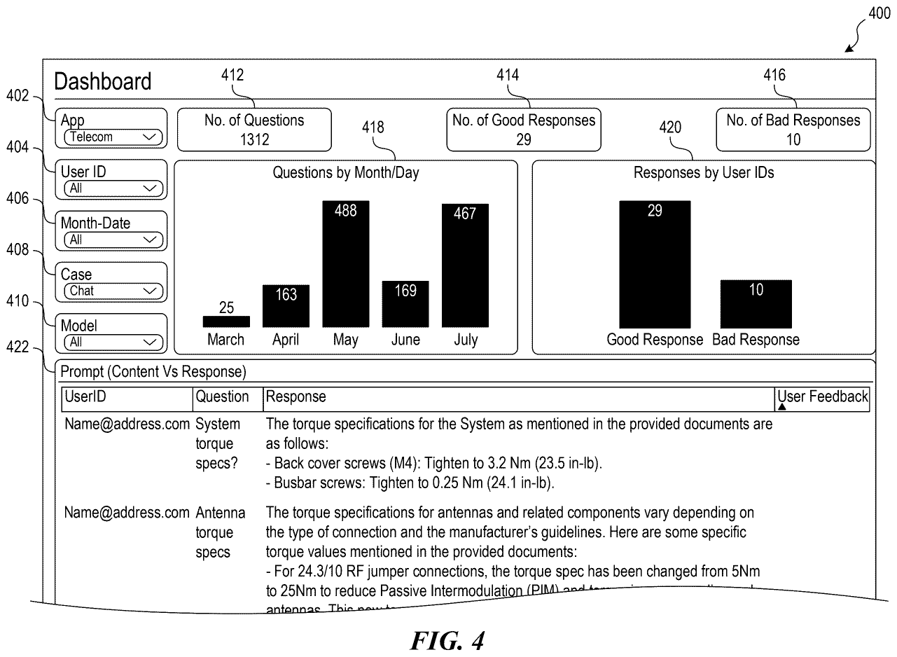

FIG. 4 is a block diagram illustrating an example dashboard 400 for monitoring the artifact generation platform's performance. The dashboard 400 includes an application selector 402, user selector 404, date range selector 406, case type selector 408, model selector 410, key performance indicators (KPIs) (e.g., total questions 412, positive responses 414, negative responses 416, and so forth), charts (e.g., time progression chart 418, response distribution chart 420, and so forth), and interaction information 422. The dashboard 400 can be implemented using components of the example computer system 700 illustrated and described in more detail with reference to FIG. 7. Implementations of example dashboard 400 can include different and/or additional components or can be connected in different ways.

The selectors (e.g., application selector 402, user selector 404, date range selector 406, case type selector 408, model selector 410) enable users to filter the data displayed on the dashboard 400. For example, the application selector 402 enables users to choose the specific application being monitored, such as “Telecom” in FIG. 4. The application selector 402 enables administrators to change the view scope of the dashboard 400 to focus on performance metrics for a particular application within the artifact generation platform. For example, the artifact generation platform can have separate applications for separate use cases (e.g., by user role, by technology domain, and so forth). In some implementations, the application selector 402 can be a dropdown menu or a set of interactive buttons/toggles to switch between multiple applications. Further, the user selector 404 enables the filtering of data based on one or more specific user identifiers or viewing data for all users. Using the user selector 404, the user and/or artifact generation platform can identify performance patterns or issues related to individual users or user groups.

The date range selector 406 enables users to view data for specific time periods, such as “Month-Date” or “All.” The temporal filtering can be used for trend analysis to identify performance changes over time. In some implementations, the date range selector can offer predefined ranges (e.g., last 7 days, last 30 days) and/or custom date range inputs. The case type selector 408 enables filtering of data based on different case types or various categories of queries or tasks used/performed by the artifact generation platform. For example, when multiple AI models are used in the artifact generation platform, the model selector 410 enables performance comparison between different models. In some implementations, the model selector can include version information and/or brief descriptions of each model's characteristics.

The KPIs (e.g., total questions 412, positive responses 414, negative responses 416) provide a summary/overview of the artifact generation platform's performance. The KPIs can include the total number of questions processed (e.g., 1312 in FIG. 4), the count of positively rated responses (e.g., 29 in FIG. 4), and the count of negatively rated responses (e.g., 10 in FIG. 4). Alternatively or additionally, KPIs can include average response time or user satisfaction scores. In some implementations, the KPIs can track the usage patterns of the platform, such as the frequency of use, peak usage times, and the types of queries most commonly submitted. The usage metrics can provide insights into how users interact with the platform and identify trends in user usage. In some implementations, the KPIs can include user engagement metrics, such as the number of active users, the average session duration, and/or the number of repeat users. High levels of user engagement can indicate that the platform is providing relevant information, while low engagement levels can indicate areas for improvement.

The charts in the dashboard 400 display visual representations of performance data of the artifact generation platform. For example, the time progression chart 418 displays the number of questions asked per month or day to illustrate the changes in generated artifacts/user queries over time. The response distribution chart 420 displays the distribution of good and bad responses by user identifiers, which can identify patterns in user satisfaction or system performance for different users. The interaction information 422, which can be presented as a table, graphical layout, and/or body of text, can provide specific information about each interaction (i.e., query-response pair), such as a user identifier, query, response, and/or user feedback. Additionally or alternatively, the interaction information 422 can include information such as response time, confidence score, and/or links to related documents.

### Example Methods of Operation of the Artifact Generation Platform

FIG. 5 is a flowchart illustrating an example method 500 for generating artifacts on the artifact generation platform. In some implementations, the method 500 is performed by the artifact generation platform including components of the example computer system 700 illustrated and described in more detail with reference to FIG. 7. The artifact generation platform can be implemented on a terminal device, a server, or on a telecommunications network core. Likewise, implementations can include different and/or additional operations or can perform the operations in different orders.

In operation 502, the artifact generation platform obtains a set of artifacts (e.g., text, audio, images, videos, and so forth) including configurations of a set of telecommunications network equipment (e.g., cellular base stations). Operation 502 includes collecting and processing various types of artifacts, such as images, videos, technical drawings, photographs, diagrams, and/or textual information that contain visual and textual information about the configuration and setup of telecommunications network equipment. The artifacts can directly contain the configurations of the telecommunications network equipment. In some implementations, reference configurations are stored separately in other artifacts or databases. In some implementations, the artifacts include PDF files or videos.

Automated scripts and application programming interfaces (APIs) can be used to fetch data from the data sources (e.g., data sources 202 in FIG. 2). Scripts can be scheduled to run at regular intervals to pull data from internal databases, cloud storage services, and/or external websites. APIs (e.g., RESTful APIs) can be used to query and download artifacts from an external system. The scripts can extract both the artifacts themselves and/or associated configuration data stored separately. For example, a RESTful API can be used to retrieve a video demonstrating the setup of a cellular base station, along with a separate JSON file containing the configuration parameters for the setup.

Text data can be processed by the artifact generation platform using natural language processing (NLP) techniques. Once the text is identified, the text can be tokenized into smaller units such as words or sentences. NER can be applied to identify and categorize key terms and entities, such as equipment names and technical specifications, by recognizing patterns in the text that correspond to specific types of information. Image data, such as technical drawings and photographs, can be classified by the artifact generation platform using convolutional neural networks (CNNs) to extract features and generate descriptions. For example, the CNNs can identify components and configurations in technical drawings by passing the image data through multiple layers of filters to detect and learn various features, such as edges, shapes, and textures. The features can be used to identify components and configurations in technical drawings. The extracted features and descriptions can be indexed along with any text data obtained from the images. Metadata such as image resolution, format, and creation date can further be captured. Audio data, i.e., in video files or stand-alone recordings, can be processed using speech-to-text algorithms. The artifact generation platform can transcribe the audio content into text and use the same or similar NLP techniques used on the text data. The transcribed text can be synchronized with the audio timestamps to enable the artifact generation platform to search for specific terms and jump to the corresponding point in the audio file.

Video data can be processed by transcribing the audio content and classifying each frame using the same or similar techniques used on image data to identify and describe the visual elements. The transcribed text and corresponding frame descriptions can be indexed and linked. For example, the artifact generation platform can extract frames from the video at regular intervals. Each frame can be evaluated to detect and identify objects, scenes, and activities by identifying patterns and features within each frame, such as shapes, colors, and textures. Once the objects and activities in individual frames are identified, the artifact generation platform can track the elements across consecutive frames to observe the elements' movements and changes over time. For example, the artifact generation platform can calculate the motion of objects by determining the changes in pixel intensity between frames and thus determine the direction and speed of moving objects, enabling the artifact generation platform to map the elements' trajectories.

In operation 504, the artifact generation platform captures an output type instruction indicative of a set of features of an artifact related to constructing and/or maintaining one or more telecommunications network equipment. For example, the artifact generation platform can capture the output type instruction via a user interface of a chat bot, an audio link (i.e., audio instructions), a user interface of an augmented reality system, a user interface of a virtual reality system, and so forth. The operation interacts with the user through a user interface (e.g., a graphical user interface) of the artifact generation platform (e.g., a chat bot), where the user can specify the desired characteristics of the artifact for generation. The output type instruction includes, for example, a format, timestamp, set of keywords, geographical location, and/or user role. In some implementations, the chat bot interface includes voice or image input capabilities for capturing user instructions.

When a user provides (e.g., types, utters, inputs, commands) a query, the artifact generation platform can use tokenization to break down the input into individual words or phrases to determine the intent behind the user's request. For example, if the user specifies a format, the artifact generation platform can recognize keywords such as “PDF” or “Word document” and maps the keywords to the corresponding output format. Voice input can be converted into text using speech recognition technology. The resulting text can be processed by the artifact generation platform in the same or similar way as typed input. The artifact generation platform can use one or more models that use the audio signals and language models to predict the most likely words and phrases. When users upload photos or diagrams, the artifact generation platform can identify relevant features within the images, such as equipment types, configurations, or labels using methods discussed with reference to operation 502. The extracted information is converted into text or structured data. In some implementations, the chat bot interface can integrate multiple input methods. Users can combine text, voice, image, and video inputs in a single interaction. The artifact generation platform can merge the extracted information into a single set of output instructions.

In operation 506, the artifact generation platform uses the output type instruction to generate the artifact. The artifact generation platform uses a first AI model (e.g., a trained LLM), or models, to generate a set of reference artifacts (e.g., images or documents) within the set obtained in operation 502. The artifact generation platform can use an embedding model to convert the output type instruction into a high-dimensional vector that captures the semantic meaning of the request. In some implementations, the first AI model can be a CNN for processing images or a transformer-based model for processing text documents. The CNN can extract features from the images, such as shapes, textures, and patterns, and convert the features into vector representations. For text documents, the transformer-based model can capture the contextual relationships between words and phrases, generating vectors that represent the semantic content of the documents.

The artifact generation platform can compare the distance between vector representations of each artifact in the set with a vector representation of the output type instruction. The artifact generation platform can convert the artifacts into vector representations. For example, for text (or transcribed audio), the artifact generation platform can generate static embeddings, where each word has a single vector representation, or contextual embeddings, where the vector representation of a word can change depending on the word's context within a sentence. The artifact generation platform can aggregate the word embeddings to create a single vector representation for the document or portion of a document (e.g., documented chunks 206). For example, the artifact generation platform can average the word vectors and/or apply attention mechanisms to weigh the importance of different words. For image and video artifacts, the artifact generation platform can CNNs to evaluate the image through multiple layers, each layer detecting different features such as edges, textures, and shapes. The output of the final layer before the classification layer of the CNN is a high-dimensional vector that represents the image's features, which can be used as the image's vector representation.

The artifact generation platform can similarly generate a vector representation of the output type instruction to use as a reference point for comparison. In some implementations, the artifact generation platform can calculate the distance between the vector representation of the output type instruction and the vectors of the artifacts using metrics such as cosine similarity or Euclidean distance. Cosine similarity measures the cosine of the angle between two vectors, indicating how similar the vectors are in terms of direction, while Euclidean distance measures the straight-line distance between two points in the vector space, indicating how close the vectors are in terms of magnitude. In some implementations, the artifact generation platform can use a clustering algorithm, such as k-means or hierarchical clustering, to group similar artifacts based on the artifacts' vector representations. K-means clustering partitions the vectors into a predefined number of clusters by minimizing the variance within each cluster, while hierarchical clustering builds a tree-like structure of nested clusters based on the similarity between vectors. The clustering results can be used to prioritize or filter the artifacts that are most relevant to the output type instruction (e.g., within the same cluster).

The artifact generation platform can generate a subset of images or documents that share one or more features with the set of features specified in the artifact request. The artifact generation platform uses the generated set of reference images or documents and a second trained AI model (or models) to generate a body of text describing the set of reference materials in accordance with the output type instruction (e.g., a summary). The generated text can include detailed descriptions, explanations, and contextual information that help users understand the reference materials. In some implementations, the second AI model can be fine-tuned on a specific corpus of telecommunications-related documents to improve the model's accuracy and relevance.

In some implementations, the artifact generation platform further refines the set of reference images by comparing the calculated relevance score of each image to a predefined threshold score. The relevance score can be derived from the similarity measure between the vector representation of the image and the vector representation of the output type instruction. The relevance score can quantify how closely each image matches the specified features in the output type instruction. The artifact generation platform filters the set of reference images by removing one or more images that fail to satisfy the predefined threshold score. The threshold can be set based on the desired level of relevance. For example, a higher threshold results in narrower, though more relevant, images, while a lower threshold allows for a broader selection of images.

In some implementations, the threshold score can be dynamically adjusted based on the context of the artifact request. For instance, if the request is for highly specific technical documentation, the threshold can be set higher to ensure that the most relevant images are included. Conversely, for more general requests, the threshold can be lowered to include a wider range of images. For example, the artifact generation platform can use one or more machine learning (ML) models that predict the threshold using historical thresholds to historical queries and/or user preferences.

In some implementations, the artifact generation platform can use additional criteria to identify the set of reference images. For example, the artifact generation platform can use the quality of the images, such as resolution and clarity, as well as metadata, such as the date of creation and source. For example, images that meet the relevance threshold but fail to meet other quality criteria can still be filtered out. In some implementations, the artifact generation platform can use ensemble methods to combine multiple relevance scores from different models. For example, the final relevance score for each image can be a weighted average of the scores from multiple models.

In some implementations, the artifact generation platform can incorporate user feedback to refine the relevance score. For example, users can review the initial set of reference artifacts and provide feedback on the artifacts' relevance and quality. This feedback can be used to adjust the relevance scores and threshold dynamically. The artifact generation platform can implement a feedback loop where user inputs are continuously collected and used to update the relevance scoring algorithms. In some implementations, to integrate user feedback into the model, the architecture of one or more models used by the artifact generation platform can include a feedback integration layer. The feedback integration layer can use the feedback as input to adjust the relevance scores accordingly. For example, the feedback integration layer can be implemented as a neural network layer that learns to map user feedback to relevance score adjustments. This layer can be trained using supervised learning, where the input is the user feedback, and the output is the adjusted relevance score. Additionally, the artifact generation platform can periodically retrain one or more models used by the artifact generation platform using the updated feedback data via online learning, where the model is incrementally updated with new data, and/or batch learning, where the model is retrained on a larger dataset that includes the new feedback.

In operation 508, the artifact generation platform displays, at the user interface of the chat bot, one or more of the following components: (i) a first component including the generated artifact, or (ii) a second component representing the set of reference images (or subset thereof) or artifacts. The generated artifact can be a report, guide, or summary. The reference artifacts can be organized into a structured format, such as a gallery or list, and each item can be accompanied by a brief description and/or indicators of the metadata. The artifact generation platform can use JavaScript to dynamically update the chat bot's user interface with the prepared components. In some implementations, the generated artifact includes hyperlinks to each artifact in the set of reference materials. Hyperlinks can be embedded within the text of the artifact using anchor tags in Hypertext Markup Language (HTML). When a user clicks on a hyperlink, the corresponding image or document is displayed in a modal window or a new tab, allowing the user to view the reference material without leaving the chat bot interface.

In some implementations, the chat bot interface can support interactive elements within the generated artifact. For example, the platform can use JavaScript libraries to create interactive charts, diagrams, and maps that users can explore. These interactive elements can provide additional context and insights, making the artifact more informative and engaging. Users can interact with these elements by clicking, hovering, or zooming. For example, the users can click on an image to bring them to a particular page in a PDF or a particular timestamp in a video.

In some implementations, the artifact generation platform calculates a relevance score for each particular image in the set of reference images. This relevance score is determined using one or more factors, including: the frequency of occurrence of the set of keywords within the particular image, the proximity of the set of keywords within the particular image, the creation date of the particular image, the modification date of the particular image, and/or a degree of confidence of a source of the particular image. After calculating the relevance scores, the artifact generation platform sorts the set of reference images in descending order based on these scores. The sorted set of reference images can be displayed at the user interface of the chat bot, enabling users to view the most relevant images first. In some implementations, the artifact generation platform associates a set of metadata with the output type instruction and the generated artifact. The metadata can include a timestamp, a user role, the set of reference images used in generating the artifact, and/or a confidence score of the generated artifact.

### Example Implementation of the Model(s) of the Artifact Generation Platform

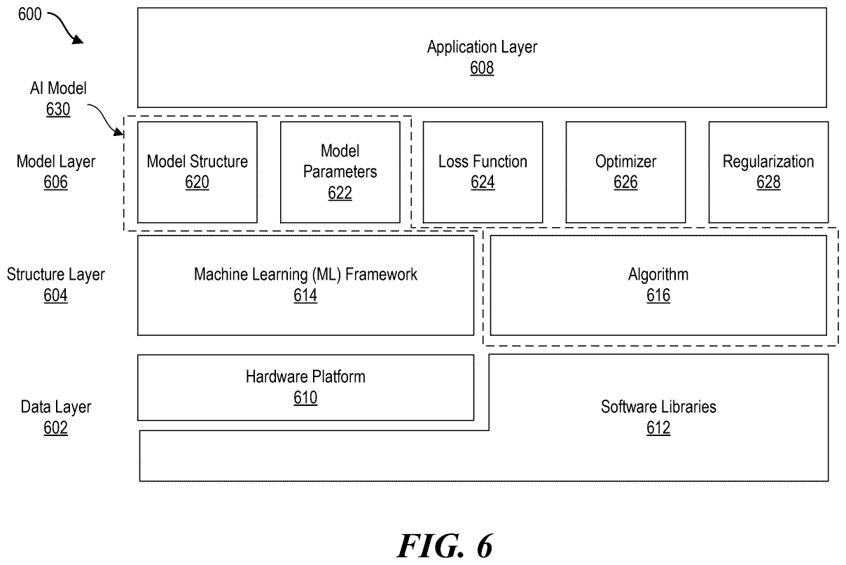

FIG. 6 is a block diagram illustrating an example artificial intelligence (AI) system 600. The AI system 600 is implemented using components of the example computer system 700 illustrated and described in more detail with reference to FIG. 7. For example, the AI system 600 can be implemented using the processor 702 and instructions 708 programmed in the main memory 706 illustrated and described in more detail with reference to FIG. 7. Likewise, implementations of the AI system 600 can include different and/or additional components or be connected in different ways.

As shown, the AI system 600 can include a set of layers, which conceptually organize elements within an example network topology for the AI system's architecture to implement a particular AI model 630. Generally, an AI model 630 is a computer-executable program implemented by the AI system 600 that analyzes data (e.g., signal strength, signal-to-noise ratio (SNR), bit error rate (BER), device location (using GPS or triangulation methods), movement patterns, data usage, battery status, processing capabilities, and/or application usage) to make predictions (e.g., the closest server, the suitable server). Information can pass through each layer of the AI system 600 to generate outputs for the AI model 630. The layers can include a data layer 602, a structure layer 604, a model layer 606, and an application layer 608. The algorithm 616 of the structure layer 604 and the model structure 620 and model parameters 622 of the model layer 606 together form the example AI model 630. The optimizer 626, loss function engine 624, and regularization engine 628 work to refine and optimize the AI model 630, and the data layer 602 provides resources and support for application of the AI model 630 by the application layer 608.

The data layer 602 acts as the foundation of the AI system 600 by preparing data for the AI model 630. As shown, the data layer 602 can include two sub-layers: a hardware platform 610 and one or more software libraries 612. The hardware platform 610 can be designed to perform operations for the AI model 630 and include computing resources for storage, memory, logic, and networking, such as the resources described in relation to FIG. 7. The hardware platform 610 can process amounts of data using one or more servers. The servers can perform backend operations such as matrix calculations, parallel calculations, ML training, and the like. Examples of servers used by the hardware platform 610 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but can be used for AI applications due to their vast computing and memory resources. GPUs use a parallel structure that generally makes their processing more efficient than that of CPUs. In some instances, the hardware platform 610 can include Infrastructure as a Service (IaaS) resources, which are computing resources (e.g., servers, memory, etc.) offered by a cloud services provider. The hardware platform 610 can also include computer memory for storing data about the AI model 630, application of the AI model 630, and training data for the AI model 630. The computer memory can be a form of random-access memory (RAM), such as dynamic RAM, static RAM, and non-volatile RAM.

The software libraries 612 can be thought of as suites of data and programming code, including executables, used to control the computing resources of the hardware platform 610. The programming code can include low-level primitives (e.g., fundamental language elements) that form the foundation of one or more low-level programming languages such that servers of the hardware platform 610 can use the low-level primitives to carry out specific operations. The low-level programming languages do not require much, if any, abstraction from a computing resource's instruction set architecture, allowing them to run quickly with a small memory footprint. Examples of software libraries 612 that can be included in the AI system 600 include INTEL MATH KERNEL LIBRARY, NVIDIA CUDNN, EIGEN, AND OPEN BLAS.

The structure layer 604 can include a machine learning (ML) framework 614 and an algorithm 616. The ML framework 614 can be thought of as an interface, library, or tool that allows users to build and deploy the AI model 630. The ML framework 614 can include an open-source library, an API, a gradient-boosting library, an ensemble method, and/or a deep learning toolkit that work with the layers of the AI system facilitate development of the AI model 630. For example, the ML framework 614 can distribute processes for application or training of the AI model 630 across multiple resources in the hardware platform 610. The ML framework 614 can also include a set of pre-built components that have the functionality to implement and train the AI model 630 and allow users to use pre-built functions and classes to construct and train the AI model 630. Thus, the ML framework 614 can be used to facilitate data engineering, development, hyperparameter tuning, testing, and training for the AI model 630.

Examples of ML frameworks 614 or libraries that can be used in the AI system 600 include TENSORFLOW, PYTORCH, SCIKIT-LEARN, KERAS, AND CAFFE. Random Forest is an ML algorithm that can be used within the ML frameworks 614. LightGBM is a gradient-boosting framework/algorithm (an ML technique) that can be used. Other techniques/algorithms that can be used are XGBoost, CatBoost, etc. AMAZON WEB SERVICES is a cloud service provider that offers various ML services and tools (e.g., SAGE MAKER) that can be used for platform building, training, and deploying ML models.

In some implementations, the ML framework 614 performs deep learning (also known as deep structured learning or hierarchical learning) directly on the input data to learn data representations, as opposed to using task-specific algorithms. In deep learning, no explicit feature extraction is performed; the features of feature vector are implicitly extracted by the AI system 600. For example, the ML framework 614 can use a cascade of multiple layers of nonlinear processing units for implicit feature extraction and transformation. Each successive layer uses the output from the previous layer as input. The AI model 630 can thus learn in supervised (e.g., classification) and/or unsupervised (e.g., pattern analysis) modes. The AI model 630 can learn multiple levels of representations that correspond to different levels of abstraction, wherein the different levels form a hierarchy of concepts. In this manner, AI model 630 can be configured to differentiate features of interest from background features.

The algorithm 616 can be an organized set of computer-executable operations used to generate output data from a set of input data and can be described using pseudocode. The algorithm 616 can include complex code that allows the computing resources to learn from new input data and create new/modified outputs based on what was learned. In some implementations, the algorithm 616 can build the AI model 630 through being trained while running computing resources of the hardware platform 610. The training allows the algorithm 616 to make predictions or decisions without being explicitly programmed to do so. Once trained, the algorithm 616 can run the computing resources as part of the AI model 630 to make predictions or decisions, improve computing resource performance, or perform tasks. The algorithm 616 can be trained using supervised learning, unsupervised learning, semi-supervised learning, and/or reinforcement learning.

Using supervised learning, the algorithm 616 can be trained to learn patterns (e.g., map input data to output data) based on labeled training data. The training data can be labeled by an external user or operator. The user can label the training data based on one or more classes and trains the AI model 630 by inputting the training data to the algorithm 616. The algorithm determines how to label the new data based on the labeled training data. The user can facilitate collection, labeling, and/or input via the ML framework 614. In some instances, the user can convert the training data to a set of feature vectors for input to the algorithm 616. Once trained, the user can test the algorithm 616 on new data to determine if the algorithm 616 is predicting accurate labels for the new data. For example, the user can use cross-validation methods to test the accuracy of the algorithm 616 and retrain the algorithm 616 on new training data if the results of the cross-validation are below an accuracy threshold.

Supervised learning can involve classification and/or regression. Classification techniques involve teaching the algorithm 616 to identify a category of new observations based on training data and are used when input data for the algorithm 616 is discrete. Said differently, when learning through classification techniques, the algorithm 616 receives training data labeled with categories (e.g., classes) and determines how features observed in the training data relate to the categories. Once trained, the algorithm 616 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 616 is continuous. Regression techniques can be used to train the algorithm 616 to predict or forecast relationships between variables. To train the algorithm 616 using regression techniques, a user can select a regression method for estimating the parameters of the model. The user collects and labels training data that is input to the algorithm 616 such that the algorithm 616 is trained to understand the relationship between data features and the dependent variable(s). Once trained, the algorithm 616 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill in missing data for ML-based pre-processing operations.

Under unsupervised learning, the algorithm 616 learns patterns from unlabeled training data. In particular, the algorithm 616 is trained to learn hidden patterns and insights of input data, which can be used for data exploration or for generating new data. Here, the algorithm 616 does not have a predefined output, unlike the labels output when the algorithm 616 is trained using supervised learning. Another way unsupervised learning is used to train the algorithm 616 to find an underlying structure of a set of data is to group the data according to similarities and represent that set of data in a compressed format.

A few techniques can be used in supervised learning: clustering, anomaly detection, and techniques for learning latent variable models. Clustering techniques involve grouping data into different clusters that include similar data such that other clusters contain dissimilar data. For example, during clustering, data with possible similarities remain in a group that has less or no similarities to another group. Examples of clustering techniques include density-based methods, hierarchical-based methods, partitioning methods, and grid-based methods. In one example, the algorithm 616 can be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 616 can be trained to be an Isolation Forest, local outlier factor (LOF) algorithm, or k-NN algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that can be used by the algorithm 616 include factor analysis, item response theory, latent profile analysis, and latent class analysis.

In some implementations, the AI system 600 trains the algorithm 616 of AI model 630, based on the training data, to correlate the feature vector to expected outputs in the training data. As part of the training of the AI model 630, the AI system 600 forms a training set of features and training labels by identifying a positive training set of features that have been determined to have a desired property in question and, in some implementations, forms a negative training set of features that lack the property in question. The AI system 600 applies ML framework 614 to train the AI model 630 such that, when applied to the feature vector, it outputs indications of whether the feature vector has an associated desired property or properties, such as a probability that the feature vector has a particular Boolean property or an estimated value of a scalar property. The AI system 600 can further apply dimensionality reduction (e.g., via linear discriminant analysis (LDA), principal component analysis (PCA), or the like) to reduce the amount of data in the feature vector to a smaller, more representative set of data.

The model layer 606 implements the AI model 630 using data from the data layer and the algorithm 616 and ML framework 614 from the structure layer 604, thus enabling decision-making capabilities of the AI system 600. The model layer 606 includes a model structure 620, model parameters 622, a loss function engine 624, an optimizer 626, and a regularization engine 628.

The model structure 620 describes the architecture of the AI model 630 of the AI system 600. The model structure 620 defines the complexity of the pattern/relationship that the AI model 630 expresses. Examples of structures that can be used as the model structure 620 include decision trees, support vector machines, regression analyses, Bayesian networks, Gaussian processes, genetic algorithms, and artificial neural networks (or, simply, neural networks). The model structure 620 can include a number of structure layers, a number of nodes (or neurons) at each structure layer, and activation functions of each node. Each node's activation function defines how the node converts data received to data output. The structure layers can include an input layer of nodes that receives input data and an output layer of nodes that produces output data. The model structure 620 can include one or more hidden layers of nodes between the input and output layers. The model structure 620 can be an artificial neural network (or, simply, neural network) that connects the nodes in the structured layers such that the nodes are interconnected. Examples of neural networks include Feedforward Neural Networks, CNNs, Recurrent Neural Networks (RNNs), Autoencoder, and Generative Adversarial Networks (GANs).

The model parameters 622 represent the relationships learned during training and can be used to make predictions and decisions based on input data. The model parameters 622 can weight and bias the nodes and connections of the model structure 620. For example, when the model structure 620 is a neural network, the model parameters 622 can weight and bias the nodes in each layer of the neural networks such that the weights determine the strength of the nodes and the biases determine the thresholds for the activation functions of each node. The model parameters 622, in conjunction with the activation functions of the nodes, determine how input data is transformed into desired outputs. The model parameters 622 can be determined and/or altered during training of the algorithm 616.

The loss function engine 624 can determine a loss function, which is a metric used to evaluate the AI model's 630 performance during training. For example, the loss function engine 624 can measure the difference between a predicted output of the AI model 630 and the actual output of the AI model 630 and is used to guide optimization of the AI model 630 during training to minimize the loss function. The loss function can be presented via the ML framework 614 such that a user can determine whether to retrain or otherwise alter the algorithm 616 if the loss function is over a threshold. In some instances, the algorithm 616 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 626 adjusts the model parameters 622 to minimize the loss function during training of the algorithm 616. In other words, the optimizer 626 uses the loss function generated by the loss function engine 624 as a guide to determine what model parameters lead to the most accurate AI model 630. Examples of optimizers include Gradient Descent (GD), Adaptive Gradient Algorithm (AdaGrad), Adaptive Moment Estimation (Adam), Root Mean Square Propagation (RMSprop), Radial Base Function (RBF), and Limited-Memory BFGS (L-BFGS). The type of optimizer 626 used can be determined based on the type of model structure 620 and the size of data and the computing resources available in the data layer 602.

The regularization engine 628 executes regularization operations. Regularization is a technique that prevents overfitting and underfitting of the AI model 630. Overfitting occurs when the algorithm 616 is overly complex and too adapted to the training data, which can result in poor performance of the AI model 630. Underfitting occurs when the algorithm 616 is unable to recognize even basic patterns from the training data such that it cannot perform well on training data or on validation data. The regularization engine 628 can apply one or more regularization techniques to fit the algorithm 616 to the training data properly, which helps constrain the resulting AI model 630 and improves its ability for generalized application. Examples of regularization techniques include lasso (L1) regularization, ridge (L2) regularization, and elastic (L1 and L2) regularization.

In some implementations, the AI system 600 can include a feature extraction module implemented using components of the example computer system 700 illustrated and described in more detail with reference to FIG. 7. In some implementations, the feature extraction module extracts a feature vector from input data. The feature vector includes n features (e.g., feature a, feature b, . . . , feature n). The feature extraction module reduces the redundancy in the input data, e.g., repetitive data values, to transform the input data into the reduced set of features such as feature vector. The feature vector contains the relevant information from the input data such that events or data value thresholds of interest can be identified by the AI model 630 by using the reduced representation. In some example implementations, the following dimensionality reduction techniques are used by the feature extraction module: independent component analysis, Isomap, kernel PCA, latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

### Example Computing Environment of the Artifact Generation Platform

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in the specification can be implemented.

The computer system 700 can take any suitable physical form. For example, the computer system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer (SBC) system, or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable (storage) medium 726) can be local, remote, or distributed. Although shown as a single medium, the machine-readable (storage) medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computing system 700. The machine-readable (storage) medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite the change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links. In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number can also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having acts, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A computer-implemented method for generating artifacts in response to a query associated with a cellular base station, the computer-implemented method comprising:
obtaining a set of images including configurations of a set of cellular base stations;
using a graphical user interface (GUI) of a chat bot, capturing an output type instruction indicative of a set of features of an artifact related to at least one of: constructing or maintaining one or more cellular base stations of the set of cellular base stations,
wherein the set of features includes two or more of: (i) a format, (ii) a timestamp, (iii) a set of keywords, (iv) a geographical location, or (v) a user role;
using the output type instruction, generating the artifact by:
using a first trained artificial intelligence (AI) model to generate a set of reference images within the set of images by comparing a distance between a vector representation of each image in the set of images with a vector representation of the output type instruction,
wherein each reference image of the set of reference images shares one or more features with the set of features of the artifact; and
using the generated set of reference images and a second trained AI model to generate a body of text describing the set of reference images in accordance with the output type instruction; and
displaying, at the GUI of the chat bot, (i) a first component including the generated artifact and (ii) a second component representing the set of reference images.

2. The computer-implemented method of claim 1, wherein the set of images includes one or more of: a document in a Portable Document Format (PDF) or a video.

3. The computer-implemented method of claim 1, wherein the generated artifact includes hyperlinks to each image in the set of reference images.

4. The computer-implemented method of claim 1, further comprising:
calculating a relevance score for each particular image in the set of reference images using one or more of:
a frequency of occurrence of the set of keywords within the particular image,
a proximity of the set of keywords within the particular image,
a creation date of the particular image,
a modification date of the particular image, or
a degree of confidence of a source of the particular image;
sorting the set of reference images in descending order based on the calculated relevance scores; and
displaying the sorted set of reference images at the GUI of the chat bot.

5. The computer-implemented method of claim 4, further comprising:
comparing the calculated relevance score of each image in the set of reference images to a predefined threshold score; and
filtering the set of reference images by removing one or more images that fail to satisfy the predefined threshold score.

6. The computer-implemented method of claim 1, further comprising:
associating a set of metadata with the output type instruction and the generated artifact, wherein the set of metadata includes one or more of:
the timestamp,
the user role,
the set of reference images, or
a confidence score of the generated artifact.

7. The computer-implemented method of claim 1, further comprising:
receiving a user input to download the generated artifact in a selected format; and
responsive to receiving the user input, automatically converting the generated artifact into the selected format.

8. A non-transitory, computer-readable storage medium comprising instructions recorded thereon, wherein the instructions, when executed by at least one data processor of a computer system, cause the computer system to:
obtain a set of images including configurations of a set of telecommunications network equipment;
using a graphical user interface (GUI) of a chat bot, capture an output type instruction indicative of a set of features of an artifact related to at least one of: constructing or maintaining one or more telecommunications network equipment of the set of telecommunications network equipment,
wherein the set of features includes two or more of: (i) a format, (ii) a timestamp, (iii) a set of keywords, (iv) a geographical location, or (v) a user role;
using the output type instruction, generate the artifact by:
using a first trained artificial intelligence (AI) model to generate a set of reference images within the set of images by comparing a distance between a vector representation of each image in the set of images with a vector representation of the output type instruction,
wherein each reference image of the set of reference images shares one or more features with the set of features of the artifact; and
using the generated set of reference images and a second trained AI model to generate a body of text describing the set of reference images in accordance with the output type instruction; and
display, at the GUI of the chat bot, (i) a first component including the generated artifact and (ii) a second component representing the set of reference images.

9. The non-transitory, computer-readable storage medium of claim 8, wherein the set of images includes one or more of: a document in a Portable Document Format (PDF) or a video.

10. The non-transitory, computer-readable storage medium of claim 8, wherein the generated artifact includes hyperlinks to each image in the set of reference images.

11. The non-transitory, computer-readable storage medium of claim 8, wherein the instructions cause the system to:
calculate a relevance score for each particular image in the set of reference images using one or more of:
a frequency of occurrence of the set of keywords within the particular image,
a proximity of the set of keywords within the particular image,
a creation date of the particular image,
a modification date of the particular image, or
a degree of confidence of a source of the particular image;
sort the set of reference images in descending order based on the calculated relevance scores; and
display the sorted set of reference images at the GUI of the chat bot.

12. The non-transitory, computer-readable storage medium of claim 11, wherein the instructions cause the system to:
compare the calculated relevance score of each image in the set of reference images to a predefined threshold score; and
filter the set of reference images by removing one or more images that fail to satisfy the predefined threshold score.

13. The non-transitory, computer-readable storage medium of claim 8, wherein the instructions cause the system to:
associate a set of metadata with the output type instruction and the generated artifact, wherein the set of metadata includes one or more of:
the timestamp,
the user role,
the set of reference images, or
a confidence score of the generated artifact.

14. The non-transitory, computer-readable storage medium of claim 8, wherein the instructions cause the system to:
receive a user input to download the generated artifact in a selected format; and
responsive to receiving the user input, automatically convert the generated artifact into the selected format.

15. A system comprising:
at least one hardware processor; and
at least one non-transitory memory storing instructions, which, when executed by the at least one hardware processor, cause the system to:
obtain a set of documents including configurations of a set of telecommunications network equipment;
using a user interface of a chat bot, capture an output type instruction indicative of a set of features of an artifact related to at least one of: constructing or maintaining one or more telecommunications network equipment of the set of telecommunications network equipment,
wherein the set of features includes two or more of: (i) a format, (ii) a timestamp, (iii) a set of keywords, (iv) a geographical location, or (v) a user role;
using the output type instruction, generate the artifact by:
using a first trained artificial intelligence (AI) model to generate a set of reference documents within the set of documents by comparing a distance between a vector representation of each image in the set of documents with a vector representation of the output type instruction,
wherein each reference document of the set of reference documents shares one or more features with the set of features of the artifact; and
using the generated set of reference documents and a second trained AI model to generate a body of text describing the set of reference documents in accordance with the output type instruction; and
display, at the user interface of the chat bot, (i) a first component including the generated artifact and (ii) a second component representing the set of reference documents.

16. The system of claim 15, wherein the set of documents includes one or more of: a document in a Portable Document Format (PDF) or a video.

17. The system of claim 15, wherein the system is further caused to:
calculate a relevance score for each particular document in the set of reference documents using one or more of:
a frequency of occurrence of the set of keywords within the particular document,
a proximity of the set of keywords within the particular document,
a creation date of the particular document,
a modification date of the particular document, or
a degree of confidence of a source of the particular document;
sort the set of reference documents in descending order based on the calculated relevance scores; and
display the sorted set of reference documents at the user interface of the chat bot.

18. The system of claim 17, wherein the system is further caused to:
compare the calculated relevance score of each document in the set of reference documents to a predefined threshold score; and
filter the set of reference documents by removing one or more documents that fail to satisfy the predefined threshold score.

19. The system of claim 15, wherein the system is further caused to:
associate a set of metadata with the output type instruction and the generated artifact, wherein the set of metadata includes one or more of:
the timestamp,
the user role,
the set of reference documents, or
a confidence score of the generated artifact.

20. The system of claim 15, wherein the system is further caused to:
receive a user input to download the generated artifact in a selected format; and
responsive to receiving the user input, automatically convert the generated artifact into the selected format.
